(19) United States
(12) Patent Application Publication
(10) Pub. No.: US 2019/0193658 A1
(43) Pub. Date: Jun. 27, 2019

(54) MODULAR SAFETY KIT

(71) Applicant: Key Safety Systems, Inc., Sterling Heights, MI (US)

(72) Inventor: Matthias Volkmann, Kronberg (DE)

(21) Appl. No.: 16/211,785

(22) Filed: Dec. 6, 2018

Related U.S. Application Data
(60) Provisional application No. 62/609,994, filed on Dec. 22, 2017.

(51) Int. Cl. B60R 21/013; A62C 3/07; B60Q 9/00; A62B 3/00

(52) U.S. Cl. CPC B60R 21/013; A62C 3/07; B60R 2021/01211; A62B 3/005; B60Q 9/00

(57) ABSTRACT

A modular safety kit for vehicles has an emergency control unit (ECU), a plurality of sensors and one or more safety devices. The emergency control unit is a computer processor with a plurality of connection ports for receiving information from sensors and sending activation signals to one or more connected safety devices. The sensors include at least one thermal sensor connected to a port and at least one linear heat detection wire connected to a port. The one or more safety devices connected to ports include a fire suppression device, a line cutter device, a line blocker device and a glass breaker device.

### FIELD OF THE INVENTION

The present invention is directed to a modular safety kit for vehicles. The kit employs automatic detection to activate a plurality of devices to extinguish fires, cut off electricity, prevent fuel leakage and various other optional features to protect occupants and first responders in the event of an incident.

### BACKGROUND OF THE INVENTION

Various safety devices for vehicles are currently available as add-on components for vehicles such as fire detection and suppression devices. The main problem with such systems is the added cost of incorporating such devices into a vehicle. The present invention described hereinafter provides a unique system with a single ECU, Emergency Control Unit, that can activate any number of safety devices coupled to the ECU. This greatly lowers the overall cost while providing a way to incorporate a variety of safety features currently unavailable.

The present invention provides a kit that is scalable and modular making it useful in passenger vehicles and light trucks. The kit functions well on petroleum fueled vehicles as well as hybrid and full electric vehicles having high voltage electric power systems.

### SUMMARY OF THE INVENTION

A modular safety system configured as a modular safety kit for vehicles has an emergency control unit (ECU), a plurality of sensors and one or more safety devices. The emergency control unit is a computer processor with a plurality of connection ports for receiving information from sensors and sending activation signals to one or more connected safety devices. The sensors include at least one thermal sensor connected to a port and at least one linear heat detection wire connected to a port. The one or more safety devices connected to ports include a fire suppression device, a line cutter device, a line blocker device and a glass breaker device.

The modular safety kit further has a human machine interface (HMI) configured to provide an optical and acoustic warning to a driver of the vehicle. The HMI is connected to the ECU. The modular safety kit further has a manual activation switch connected to the HMI to direct the ECU to activate one or more of the connected safety devices. The vehicle further has a hazard warning system connected either directly to the ECU or a separate vehicle ECU connected to the HMI or connected directly to the ECU. The hazard warning system includes vehicle crash sensors which send a signal to the ECU in the event of a vehicle crash. The modular safety kit is especially suited for commercial transport vehicles such as buses or commercial trucks.

### BRIEF DESCRIPTION OF THE DRAWINGS

The invention will be described by way of example and with reference to the accompanying drawings in which:

FIG. 1A is a schematic view of the Modular Safety Kit generally according to the present invention.

FIG. 1B is a schematic view describing the basic functions of the kit.

FIG. 2A is a second schematic view further explaining the standard system functions.

FIG. 2B is an advanced first embodiment schematic I system function.

FIG. 2C is an advanced second embodiment II system functions.

FIG. 3 is an exemplary flow chart for the Modular Safety Kit of the present invention.

FIG. 4 is an exemplary cross-section view of a line blocker device.

FIG. 5 is an exemplary cross-section view of a line cutter device for use with the present invention.

FIG. 6 is an exemplary cross-section view of a high voltage line cutter for use with the present invention.

### DETAILED DESCRIPTION OF THE INVENTION

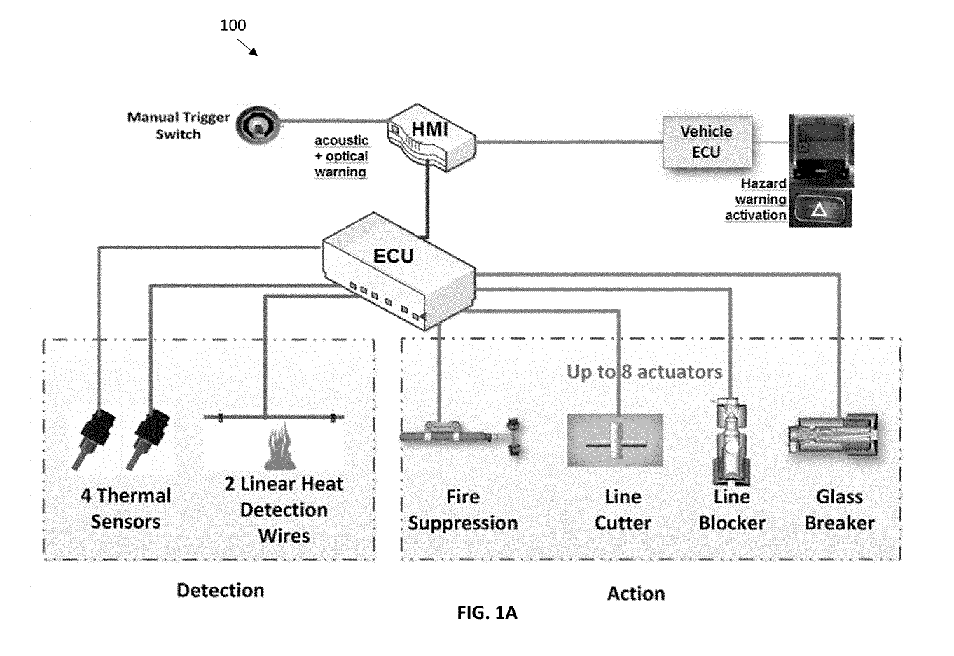

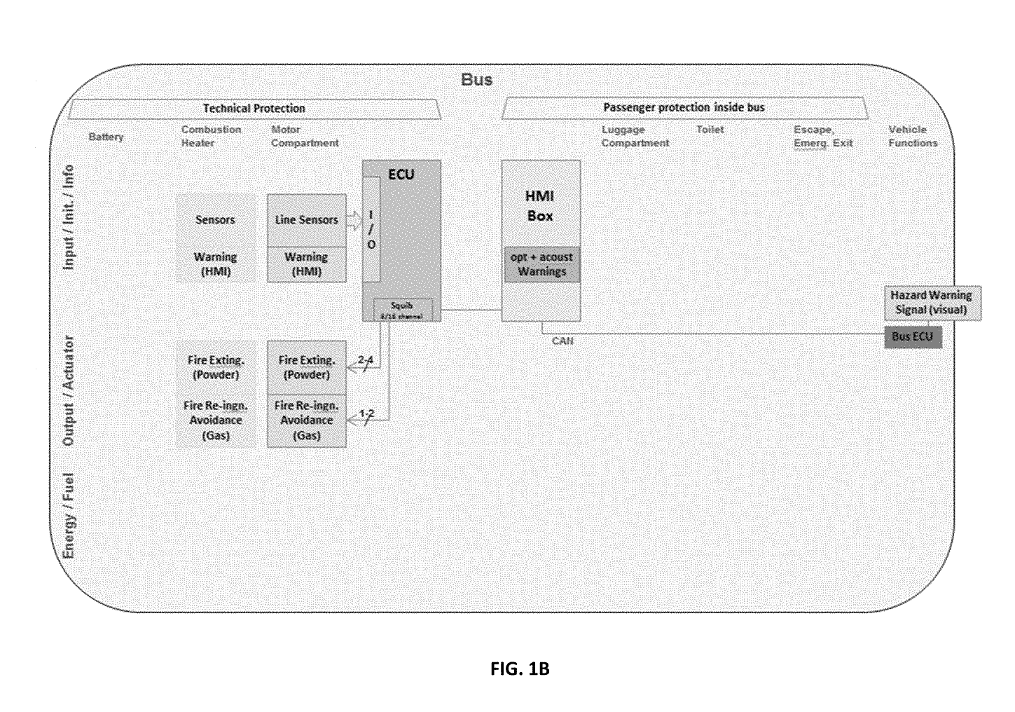

With reference to FIG. 1A, a modular safety system configured as a modular safety kit 100 is illustrated. The modular safety kit 100 is a modular system that has a number of safety components used to protect a vehicle in the event of a vehicle fire or crash wherein the system will activate a plurality of safety devices to protect the occupants from fire or electrical hazards or other hazards from fuels or spilled liquids. As shown, a primary component of the modular safety kit 100 is an emergency control unit (ECU). The ECU is a computer with a microprocessor that has a plurality of connection ports to which a plurality of sensors can be connected. The sensors when used as thermal sensors, can determine increases in heat. In addition, along the electrical lines, there are linear heat detection wires that can be installed into the system and connected to the ECU as shown. These detection sensors provide input into the ECU in the event of a fire or thermal heat rise wherein a hazardous condition may occur. On the right hand side of the figure are a plurality of devices wherein a fire suppression system is connected to the ECU, a line cutter device is connected to the ECU and a line blocker device is connected to the ECU. Additionally, a glass breaker device can be provided for safety of the occupants in the event of an immediate need to egress a vehicle. These glass breakers are particularly useful in commercial vehicles such as buses where the occupants may need to get out of the vehicle as quickly as possible.

The sensors will provide information to the ECU in the case of an event, particularly a thermal event which will then activate the various safety devices connected to the ECU.

In addition to the ECU an HMI device (human machine interface) can be connected to the ECU, the HMI can be a touchscreen or display on the dashboard of the vehicle allowing the driver to know the condition of the ECU and the vehicle at all times. The HMI will be provided with acoustic and optical warning capabilities that will alert the driver to any condition. In addition, a manual trigger device will be provided to the driver in the event he needs to activate one or more of the devices in a manner preceding an automatic response by the ECU. Ideally, connected to the HMI is an addition vehicle ECU that is used for hazard waring activation in the event of a vehicle crash. The vehicle ECU is a secondary ECU standard on most vehicles that would alert the vehicle and activate airbags and other such devices if employed on the vehicle in such a fashion to protect the occupants. When a signal comes from the vehicle ECU back to the HMI it is then transmitted to the modular safety kit ECU to ensure that the modular safety kit ECU is aware of the fact that a vehicle crash or incident has occurred.

The sample functional specifications for the modular safety kit 100 is that the safety kit is always working whether driving or not once the system is connected to the vehicle's battery. At least two thermal sensors for redundancy are provided. However, for commercial vehicles, the number of thermal sensors should be identified and defined according to the evaluation of the engine compartment heat distribution profile. Work with the power supply ranges from 12 to 24 Volts DC. The linear heat detection wire or LHDW is a backup system used to trigger the fire suppression device within 30 seconds or less once the temperature threshold has been reached. A warning to the driver while it triggers the fire suppression uses a buzzer and light to create both an optical and an acoustic warning to the driver. The system runs self-diagnostics all the time to check the status of the control system and the connected thermal sensors to verify there are no squib failures in the event of a pyrotechnic safety device such as a line cutter or line blocker type device. And a micromalfunction to make sure the are no errors in the computer system. If there are errors detected, they are reported for corrective action. As mentioned, a manual trigger is provided for human override. The system records an error code and the deployment for after event investigation purposes. The thermal sensors can be configured using the rate of rising temperature and its threshold.

With reference to FIG. 1B a typical modular safety kit 100 is laid out in block diagram for a commercial bus. As indicated, the hazard warning signal and bus ECU are provided on the right side of the diagram which are then connected to a gateway on the HMI and ethernet connection is provided back to the modular safety kit ECU. As indicated line sensors are provided that are connected with an on/off switch. When a line sensor is activated a signal is sent to the ECU and a squib can be fired on any one of a number of safety devices connected to the ECU.

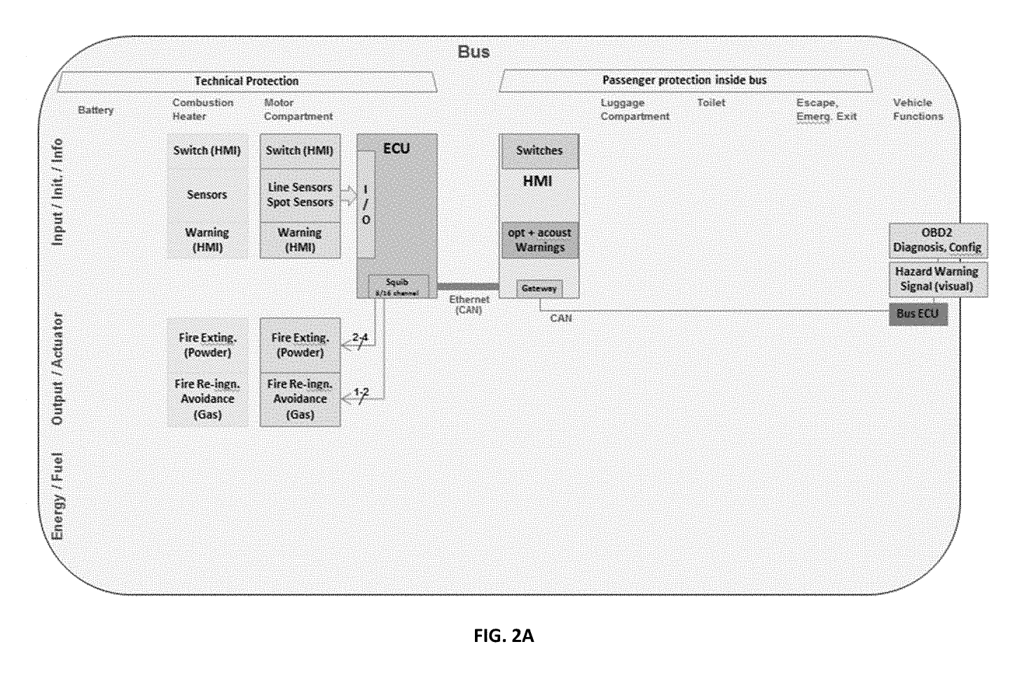

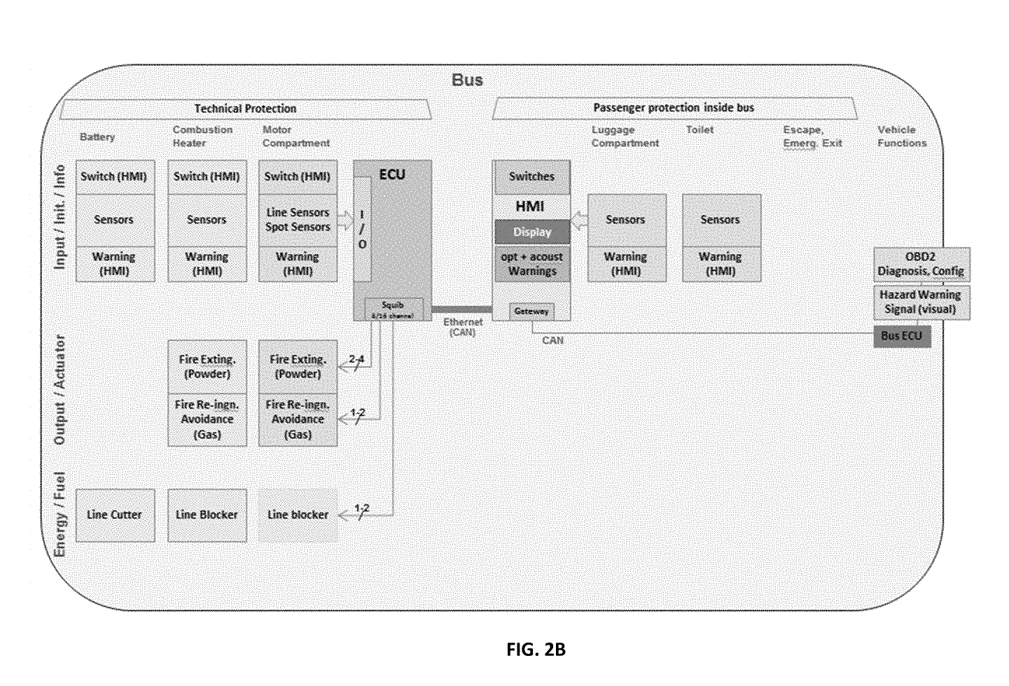

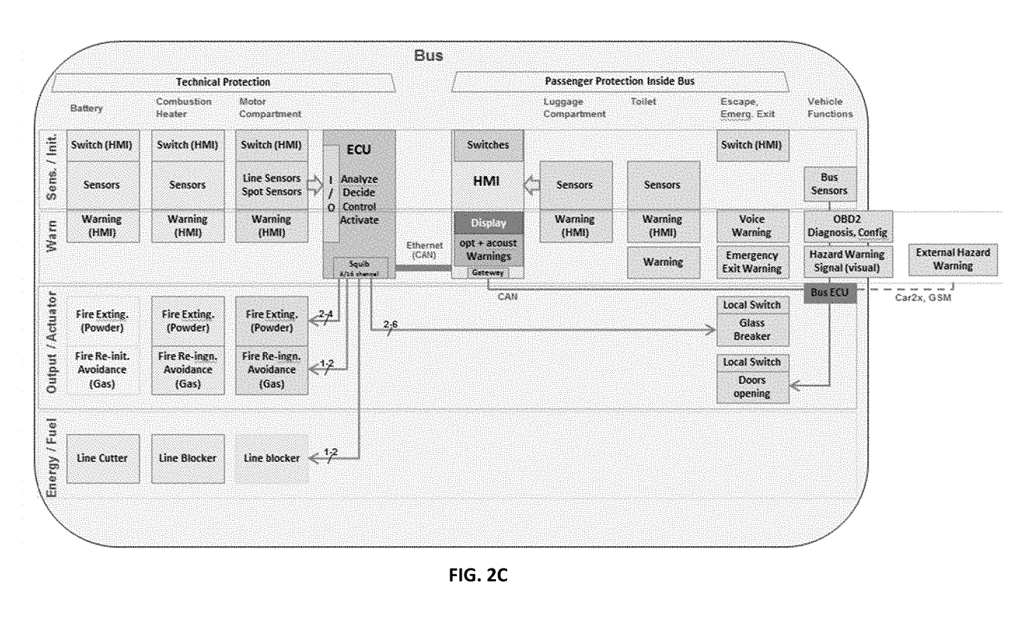

This diagram in FIG. 1B is the most basic of the systems provided and provides the most basic functions. FIG. 2A is a slightly more advanced system that provides on the right-hand side above the bus ECU the diagnostics configuration, the hazard warning visual indicator and switches connected to the HMI. Otherwise the components are very similar to what is shown in FIG. 1B. FIG. 2B is an even more advanced system providing additional features as is FIG. 2C. As shown in FIG. 2B, line cutter and line blocker devices are provided as well as fire extinguishing and suppression systems with powder and gas are provided and a number of line sensors and spot sensors are provided. In addition, sensors are connected to the HMI providing additional capabilities and warnings to the driver.

In FIG. 2C a glass breaker is provided for a commercial bus that is connected to a local switch that will activate breaking the windows allowing occupants to egress from the vehicle in the event of a vehicle crash. Additional warnings and systems are provided making this a more advanced system. Ideally, the system will not only alert the driver, but send a GPS coordinate and warning system to first responders such that the vehicle can be identified quickly and emergency crews can get to the scene of the fire or accident.

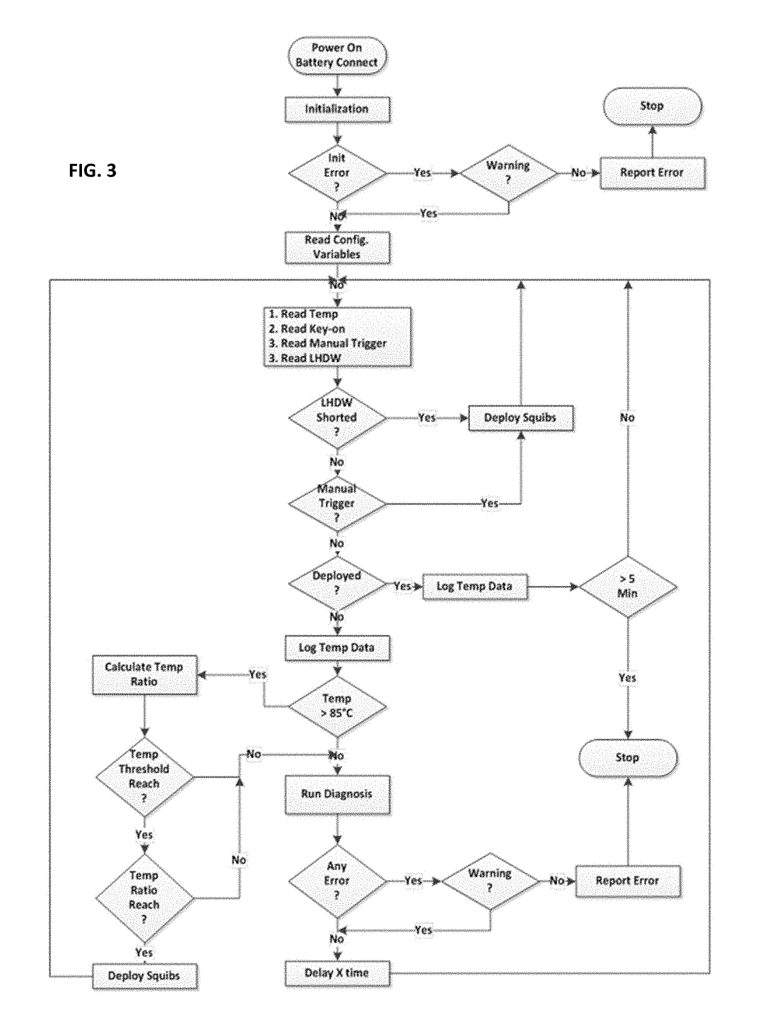

With reference to FIG. 3, a flow chart is shown explaining how the modular safety kit 100 functions in the event of a condition. The system is always self-diagnosing and checking to make sure there are no errors in the system. The deployment of the safety devices occurs automatically in the event of a sensor readout as shown in the flow diagrams.

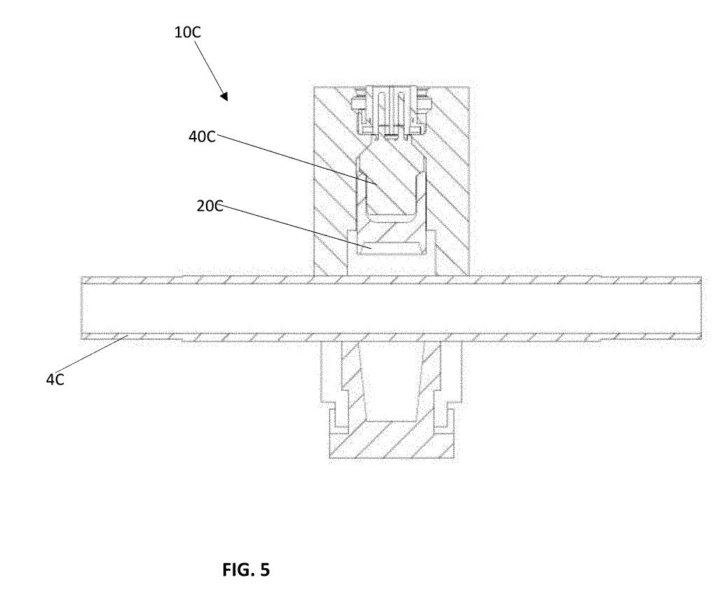

Referring back to FIG. 1A, a fire suppression system is shown under the block entitled actin. The fire suppression system can be either powder or gas and provide a way extinguishing a fire, for example, in the engine compartment. In addition, a line cutter can be provided. A line cutter can cut, for example, the air conditioning system line that is under pressure so the Freon in the air conditioning system escapes and does not enter the passenger compartment of the vehicle in the event of a catastrophic failure of that system. An exemplary line cutter device 10C is shown in FIG. 5.

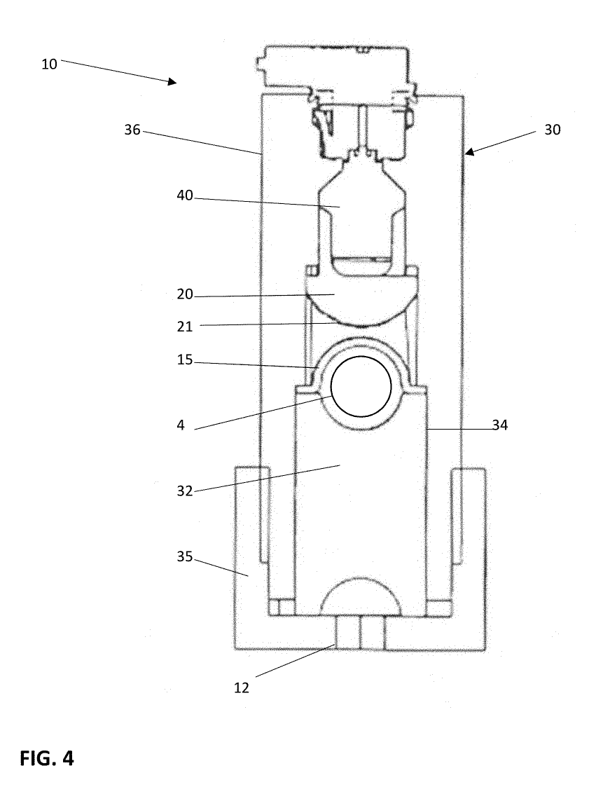

In addition, various fuels are on commercial vehicles such as gasoline or diesel. In the event of a crash where there is a fire, a line blocker can be used to ensure that the fuel from the fuel tanks is not delivered to a burning engine compartment. A fuel line blocker 10B is illustrated in FIG. 4. The line blocker 10B has a pyrotechnic squib 40 and a plunger 20 with a rounded end 21 that will impact a deformable shield 15 wrapped around a line 4. This assembly is a two-part assembly that can be bolted onto any line. The internal housing 30 has an upper portion 36 that holds the squib 40 and is electrically connected to the ECU and is activated when a sensor activates a line blocker 10B to close a line 4. On closing, the squib 40 fires the plunger 20 that will compress the line 4 and seal it so that no fluids can leave the tank.

An exemplary line blocker device 10B is shown on a section of an exemplary fluid line 4 by way of example, the line 4 can be a fluid line for carrying a combustible fluid like gasoline or diesel fuel. In a preferred embodiment, the device 10 clamps on the outside of the line 4, it is not intrusive. With a fluid line system there are always concerns of weak parts of the system. This device 10 does not add a potential leak path to the system. It clamps over the line 4 and it has an electrical connection on the outside and one or more vent holes 12 in the bottom portion or cap 35 of the housing 30. The electrical connection has a wiring harness in a tube extending to a connector that can be wired to a vehicle crash detection system or in this case, the modular safety kit 100 ECU. Upon receipt of an accident signal, similar to that which would fire an airbag would also activate this device 10, and immediately block the fluid line to the engine compartment external of the passenger compartment, preferably near the fuel tank. The intention is to make sure there is no opportunity for fuel to spill onto a hot engine or muffler and ignite or for the gas vapors to vent where the occupants are because the vapors could achieve a high enough concentration in the air in the passenger compartment to reach a toxic or explosive level. The present invention is also a safety device to control the line spillage and to make sure that there is no potential for the occupants to be exposed to a fuel fed fire.

The igniter 40, in its simplest form is preferably a pyrotechnic device. When a signal is received by this igniter 40, a fuel element burns and ignites an adjacent pyrotechnic charge which generates a shock wave that propels a piston to close the line 4 and not allow fluid to leak out and exit through any breaks in a line. Another more preferred way is to block the line 4 by propelling a piston 20 into a deformable element 15 positioned on or adjacent the line. The deformable element 15 deforms as it is forced against the line by the piston 20 causing the line 4 to change shape and close upon itself thereby entirely closing a section of the line leaving the line sealed and tightly closed. The device 10 in this particular state simply clamps over a line 4 so it can be taken off for service and replaced without actually interfering with the fluid line system in any way.

One of the key features of this is that it is not invasive, not intrusive to the fuel system. It is serviceable; it can be unclamped from the fuel line, replaced if for any reason there was warranty work. To insure the igniter 40 is functional, a monitoring pulse can be sent to the igniter 40 and check the integrity of the electrical circuit on a constant basis and activate a warning light in the car should the device 10 become defective and non-functional. This approach is similar to a feature on airbags to monitor the electrical circuit. If the device 10 becomes defective, and as mentioned it could simply be disconnected and replaced without interfering with the fuel line system.

In the above embodiment, the line 4 can be made of many materials including, but not limited to plastic or rubber and the deformable element 15 can be made of a deformable metal. To avoid any dissimilar material reactivity or corrosion issues, the device 10B can be made from aluminum with the exception of the housing of the igniter 40 which is plastic and the electrical interface is plastic. Ideally the device uses as much plastic as possible to reduce cost, reduce weight. Since the plastic won't react to the aluminum, the entire housing may be plastic.

The device 10B has the three housing pieces assembled together: an upper housing portion 36, an internal support 32 and the bottom cap portion 35. They are snapped or screwed together to apply a sufficiently high clamping force to the line 4 to reduce vibration and to keep the part from rotating on the line. It is important the device 10B not rotate or vibrate relative to the line 4. Preferably, the device 10 would be oriented with the upper portion with the igniter facing upward. This orientation would minimize any water or sediment from getting into the igniter area and obstructing the function of the igniter 40. By having the electrical connection in the upward position and orienting it in the vehicle it would allow water to drip away from the igniter 40 and never solidify in the event of freezing temperatures, etc.

The blocking element 20 can be any metal, preferably stainless steel or aluminum to prevent a reaction with the housing 30 which can also be aluminum or even plastic. The device 10B must go through 700 hours of salt mist exposure as part of a qualification so it is important there is no reactive features.

The internal support portion 32 can be a cylindrical post in the bottom cap portion 35. In this particular device, when one screws the bottom cap portion 35 in, the top of the cylindrical post 32 has a concavity that pushes up directly against the line 4. The upper portion 36 has an inner diameter large enough to accept the blocking piston or element 20. In FIG. 5, the piston 20 is shown actually sitting inside the chamber 34 in the upper portion 36. The chamber 34 is intended to direct the piston into the deformable element 15, collapsing it toward the concavity at the upper edge of the cylindrical post 32 in this way the deformable element 15 would collapse and close the line 4. The piston 20 is moved when the igniter 40 is fired. The piston 20 impacts and pushes the deformable element 15 against a top portion of line 4 to seal the line 4 to hold it closed with the deformable element 15 locked on top of the sealed line 4. The device 10B is configured to have the end of the element 15 held so the element 15, once collapsed, cannot spring open locking in the closed line position.

Contained in the top portion 32 is the igniter 40, it is shown with a body, the wider diameter can be a molded plastic that has an 11 mm diameter. At the top portion 36 of the housing 30 is shown a molded connector pocket interface. In airbags this is machined in, but there is a cost advantage to mold the connector. The connector is shown as an insert into the upper housing portion 36 with the electrical interface being a molded aspect. The igniter 40 would then mount from below the top housing portion 36 being inserted from the bottom, above the piston 20 and the deformable element 15 and the internal housing support 32 and bottom end cap portion 35. The upper housing portion 36 can be made of aluminum. The piston 20 has a lower spherical shaped end chamber end 21 that, as shown, encircles the igniter 40 and can be used to hold the igniter 40. Preferably, the igniter 40 is molded into the upper housing 36 or mechanically snaps it into the upper housing 36. The piston chamber end 21 is cup shaped and encircles the charge cup of the igniter 40 so the igniter 40 will fit down inside of the piston chamber end 21 of the piston 20. By having the piston chamber end 21 encircle the charge cup allows the piston 20 to get the proper proximity to maximize propulsion so that when the igniter energy is released, it is most effective to propel the piston 20. If the piston chamber is spaced too far away from the charge cup, a lot of igniter energy is lost and that wasted amount of energy is lost prior to getting the piston 20 to move. The deformable element 15 is preferably positioned directly above the line 4.

One novel aspect for this device 10B is that it is a device that could clamp onto any line in any system at any time and be able to be taken on and off without interfering with the lines.

With reference to FIG. 5, a line cutter 10C is illustrated. The line cutter 10C, as illustrated, also employs a squib 40C, but in this case, instead of a plunger a cutting element 20C is provided. In such a case, the line 4C which may be carrying Freon or other gaseous fluids can be cut in the engine compartment area and allow the gases to be vented to the atmosphere, thereby protecting the occupants from a rupture of such a line in the passenger compartment. Unlike the line blocker 10B, there is no capturing and preventing of fluid flow, but rather a release and venting of the fluids.

An exemplary line cutter device 10C is shown on a section of the line 4C pressurized to the operating range of the refrigeration system. In a preferred embodiment, the device 10C clamps on the outside of the line 4C, it is not intrusive. With a high pressure system there are always concerns of weak parts of the system. This device 10C does not add a potential leak path to the system. It clamps over the line 4C and it has an electrical connection on the outside and vent holes in the sides of the housing that are opposed to each other so that when the gas exits it is thrust neutral, it doesn't tend to propel in any direction. Upon an accident signal, the same as one that would fire an airbag would also signal this device 10C, and immediately begin venting the high pressure CO2 in the engine compartment external of the passenger compartment. The intention is to make sure that there is no opportunity for the CO2 to vent where the occupants are because the CO2 could achieve a high enough concentration in the air in the passenger compartment to reach a toxic level. This is a safety device to control the venting to make sure that there is no potential for the occupants to be exposed to high levels of CO2 refrigerant.

The way it works is to have an igniter 40C, preferably a pyrotechnic device, and in its simplest form, when a signal hits this igniter 40C, an element burns and it ignites the pyrotechnic charge and that generates a shock wave that actually fractures the line 4C and allows the pressurized CO2 to leak out and exit through the vent holes that are in the sides of the housing. Another way is to open up the line 4C by propelling a piston or cutting element 20C with a cutting edge on it that actually shears through the line 4C and entirely removes a section of the line leaving both ends of the line open to very adequately release all of the compressed medium through the vent holes. The design in this particular state simply clamps over a line so it can be taken off for service and replaced without actually interfering with the A/C system in any way.

One of the key features of this is that it is not invasive, not intrusive to the A/C system. It is serviceable; it can be unclamped from the A/C line, replaced if for any reason there was warranty work. It has a feature with the igniter 40C that a monitoring pulse can be sent to the igniter 40C and check the integrity of the electrical circuit on a constant basis and put on a warning light in the car should the device 10C become defective and non-functional. That is similar to a feature on airbags to monitor the electrical circuit. If the device 10C becomes defective, it could simply be disconnected and replaced without interfering with the line or depressurizing the A/C system.

The material is aluminum in the lines 4C. To avoid any dissimilar material reactivity or corrosion issues, the device 10C is made from aluminum with the exception of the housing of the igniter which is plastic and the electrical interface is plastic. Ideally the device uses as much plastic as possible to reduce cost, reduce weight, the plastic won't react to the aluminum, accordingly the housing may be plastic. There is no current intention of making the part of steel or stainless steel because it poses the potential to react. There may be systems in the future with stainless steel lines in which case it may be advantageous to make this part of stainless steel, but for now the focus is on aluminum and plastic.

The early prototype design brought the two housing pieces together by having an internal thread in the upper housing and the bottom portion has a male thread. They are screwed together to apply the clamping force to the line for vibration reasons and to keep the part from rotating on the line. It is important that it not rotate or vibrate. Preferably, the devices 10C would be oriented with the part with the igniter 40C facing upward. This would prevent any water or sediment from getting into the igniter area and obstructing the function of the igniter 40C. By having the electrical connection in the upward position and orienting it in the vehicle it would allow water to drip away from the igniter 40C and never solidify in the event of freezing temperatures, etc.

The cutting element 20C is aluminum to prevent a reaction with the housing which is also aluminum, it must go through 700 hours of salt mist exposure as part of a qualification so it is important there is no reactive features.

There is a hollow cylindrical post on the bottom portion. In this particular prototype concept, when you screw that in, the bottom of the cylindrical post pushes up against the line 4C and it has an inner diameter large enough to accept the piston or cutting element 20C.

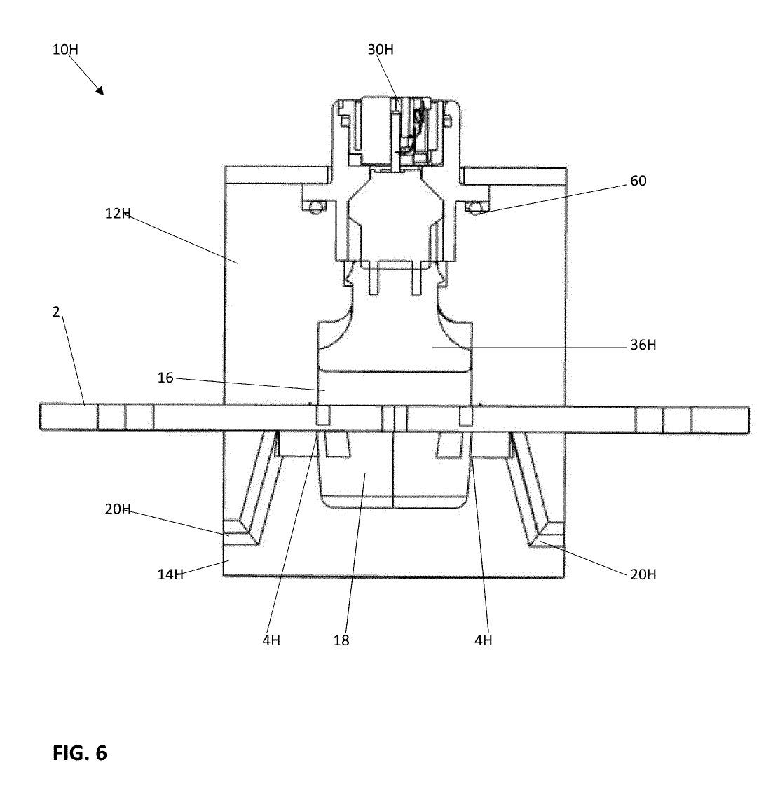

An electric line cutter device 10H for high voltage busbars 2 is illustrated in FIG. 6. The device 10H has an upper housing 12H and a lower housing 14H. Sandwiched between the upper 12H and lower housing 14H is a busbar 2. The busbar 2 is designed to carry high voltage currents and can be used as a means for carrying power from a battery system to the various components of a vehicle as way of example.

Shown at a top portion of the device 10H are electrical connections for an igniter 30H. This forms a pyrotechnic device that is capable to propel a piston 36H contained within chambers 16, 18. The piston 36H is contained in chamber 16 of the upper housing 12. The chamber 18 the lower housing 14H is shown with a slight inward taper, as illustrated. When the igniter 30H is activated by an electronic signal sent from a vehicle crash detection system such as the modular safety kit 100 ECU, the squib fires the propellant and propels the piston 36H toward the busbar 2. If there is a fire in the vehicle, the busbar can be cut when the cutter gets a defined signal. A pyrotechnical actuator separates electric high voltage battery connection in an electric vehicle irreversibly from the drive train. It is triggered by the ECU in case of a crash to prevent electric shock hazards or fires due to overcharge of battery or short circuits within the system. The ignitor receives a certain current of for example, 1.75 A for a certain time, such as 500 msec.

The busbar 2, as illustrated in FIG. 6, has a pair of fracture locations 4H on each side of the busbar 2. These fracture locations 4H are reduced thickness sections of the busbar 2 capable of carrying the current, but providing a means of fracturing the busbar 2 in two parts thereby disrupting the current flow. Under normal operating conditions, the busbar 2 is a continuous piece, however, during a vehicle crash, the igniter 30H receives a specific signal from a crash detection system or from another control unit such as the safety computer or airbag ECU, preferably an airbag crash detection system and is activated. When this occurs, the piston 36H is driven downward into the chamber 18. During this fracturing of the busbar 2 and disruption of the current, arcs can occur. These arcs create discharges and gas discharges inside the electric cutter device 10H, as such these gases can be dispelled through passages 20H that create open vent passages to allow the gas to discharge. The piston 36H is made of non-conductive material (typically plastic). The material may also be ceramic. The piston 36H has several functions: Transformation of the gas pressure from the igniter 30H into kinetic energy of the piston 36H; Cutting of the busbar electrical insulation of the two busbar stub ends after cutting; Division of the current into two separate current flows and electric arcs; Extension of the arcs by moving the cut-out busbar part away from the power rail stub ends.

The object is to be able to switch off very high currents up to 16 kA and voltages up to 1000 V in a very small space in a very short time <2 msec.

The task is solved by a galvanic separation of a busbar 2 using a pyrotechnic device 30 and by extinguishing the electric arc using simultaneously several methods: extension of the arc with simultaneous cooling and squeezing.

These devices described above and the optional glass breaker, provide an ideal safety system feature for commercial vehicles such as buses or trucks. In the event of a vehicle crash or fire where the occupants need to egress immediately from the vehicle, glass breakers can be provided to assist the occupant in egressing out window openings, in the event the vehicle has rolled over or the doors are blocked such that the occupants can leave the vehicle in timely manner. As shown, the modular safety kit 100 can have any number of sensors provided and these sensors can be used to activate any number of safety devices depending on the size of the vehicle and the specifications of the vehicle warranting the placement of such devices.

As shown, the modular safety kit 100 as described provides a unique way to meet the UNECER107 regulations for buses which requires an automatic detection, warning and extinguishing of fires in engine compartments and in compartments where combustion heaters such as auxiliary heaters are located. This system provides a unique way that can further provide added features such as line blockers, line cutters and glass breakers and emergency exit warnings to the system using the common ECU and HMI system provided in the modular safety kit 100. As noted, the system can be modified to the exact specifications of any commercial vehicle or bus. Further, it can be employed on passenger vehicles, if so desired. In passenger vehicles, a new requirement for electric and high voltage hybrid vehicles. The high voltage system needs to be disengaged from the vehicle in the event of a crash to allow first responders to assist and to allow occupants to exit the vehicle without fear of electrocution. As shown in FIG. 6, this high voltage system is a line cutter, but with an electrical arc suppression system such that an electric vehicle can be provided with a modular safety kit 100 if so desired. The first responders can then safely approach occupants to assist in the event of a crash without the risk of the high voltage electricity running through the frame of the vehicle that could electrocute any person trying to assist. This is an added modification that can be provided to the modular safety kit 100 and just many variations that can be provided for any type of vehicle used in the future.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A modular safety kit for vehicles comprises:
an emergency control unit (ECU), the emergency control unit being a computer processor with a plurality of connection ports for receiving information from sensors and sending activation signals to one or more connected safety devices; the sensors including:
at least one thermal sensor connected to a port;
at least one linear heat detection wire connected to a port; and
one or more safety devices connected to ports including:
a fire suppression device, a line cutter device, a line blocker device and a glass breaker device.

2. The modular safety kit of claim 1 further comprises:
a human machine interface (HMI) configured to provide an optical and acoustic warning to a driver of the vehicle, the HMI being connected to the ECU.

3. The modular safety kit of claim 1 further comprises:
a manual activation switch connected to the HMI to direct the ECU to activate one or more of the connected safety devices.

4. The modular safety kit of claim 1 wherein the vehicle further comprises a hazard warning system connected either directly to the ECU or a separate vehicle ECU connected to the HMI or connected directly to the ECU.

5. The modular safety kit of claim 4 wherein the hazard warning system includes vehicle crash sensors which send a signal to the ECU in the event of a vehicle crash.

6. The modular safety kit of claim 1 wherein the vehicle is a bus or commercial truck vehicle.
